(19) United States
(12) Patent Application Publication
(10) Pub. No.: US 2006/0280045 A1
(43) Pub. Date: Dec. 14, 2006

(54) Portable media reproduction system

(75) Inventors: Kenneth Ritsher, Chicago, IL (US); Rick Messerle, Port Jervis, NY (US); Eric Aaron Langberg, Milford, PA (US); Eran Schul, Milford, PA (US)

Correspondence Address: GREENBERG-TRAURIG, 1750 TYSONS BOULEVARD, 12TH FLOOR, MCLEAN, VA, 22102, US

(73) Assignee: Altec Lansing Technologies, Inc., Milford, PA (US)

(21) Appl. No.: 11/244,928

(22) Filed: Sep. 7, 2005

Related U.S. Application Data
(60) Provisional application No. 60/685,415, filed on May 31, 2005.

(51) Int. Cl. G11B 21/08

(52) U.S. Cl. 369/30.01

(57) ABSTRACT

A portable media reproduction system into which a portable media player can be inserted. The portable media reproduction system includes a docking component wherein the size of the docking component can be adjusted to fit a given portable media player. The portable media reproduction system also includes a video output connector, a subwoofer, and a passive radiator.

This application claims priority to provisional application Ser. No. 60/685,415 filed May 31, 2005, the entire disclosure of which is incorporated herein by reference. This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of portable media playback equipment, and in particular to portable devices for reproducing audio signals.

### BACKGROUND OF THE INVENTION

The past several decades have seen remarkable advances in audio and video reproduction equipment, particularly equipment that allows a variety of audio tracks to be carried or transported with a user from one location to another. Such equipment includes, e.g., equipment for digitally recording, editing, mixing, producing, storing and reproducing audio tracks. Digital files are advantageous for several reasons, including the fact that running error correction algorithms on the files can guarantee that the audio track data in the files is properly stored, which means that the audio can be faithfully reproduced even where an underlying recording medium induces errors or where errors are induced in the copy process. Another advantage of digital files is that reproduction equipment can precisely control the speed at which the audio track is played, thereby effectively guaranteeing consistent playback.

In recent years, new algorithms for storing audio tracks have emerged. One of the more popular of these new audio track storage algorithms is the Motion Picture Entertainment Group level 3 algorithm, commonly referred to as the “MP3” algorithm. The MP3 algorithm uses a variety of techniques, including allowing users to vary the audio track sampling rate as the audio track is recorded, varying the number of bits used to represent a given frequency range, and the like, to generate digital audio track files that are significantly smaller than those used on CD's. This means that users can carry more audio data files on a given medium than they could in the past. For example, a typical seventy-two minute audio CD holds approximately 650 MB of data. Depending on the compression methods chosen, a 650 MB CD-ROM has sufficient capacity for several hours of compressed music.

As digital storage capacity continues to increase and compression algorithms continue to advance, users are able to carry more and more of the music they like with them. This has resulted in the incorporation of audio track reproduction capabilities in an ever-increasing array of audio-capable devices, including, but not limited to, digital cameras, portable digital assistants (“PDA's”), wireless telephones, and the like. Several other devices, generally referred to as portable media players (“PMP's”), have been introduced into the market that are predominately used for reproduction of compressed audio tracks. One of the most popular PMP's is the iPod, sold by Apple Computer, Inc. of Cupertino, Calif. The iPod has become popular because it has a relatively small form factor but can store many gigabytes of audio files and other information on a hard disk drive stored within the PMP. Other PMPs additionally store video information for playback on a small display integrated into the device.

Most of the currently available audio devices are designed to be highly portable and to allow an individual to carry a relatively large number of audio tracks. However, because design of these devices has centered on portability, manufacturers tend to limit them so as to present the reproduced audio to a user only through monaural or stereo headphones that are plugged into the audio device. This means that, at best, these audio devices can only be used to reproduce audio tracks for a limited number of users, such as where one or more splitters are used to allow multiple users to plug headphones into the device. However, because the audio devices are typically battery powered, they are not capable of generating enough energy to power several pairs of headphones. Furthermore, increasing the number of users connected to a single device beyond one or two limits the device's portability.

One method alternatively employed by some in the prior art is to allow users to attach speakers to a portable media player. This allows multiple users to experience audio tracks at the same time. Because the power output of audio devices is typically relatively low, it is frequently advantageous for the speakers to include an amplifier which is powered by an external power source. Some in the prior art have created relatively small, battery powered or alternating current (AC) powered speakers for use with portable audio reproduction equipment. These speakers tend to take a lot of physical abuse during transportation, and frequently the cables and adaptors used to connect the speakers to the audio device are not capable of withstanding such abuse.

One solution offered on the market is the original inMotion™, available from Altec Lansing Technologies, Inc., of Milford, Pa., and described in U.S. patent application Ser. No. 10/836,113 filed Apr. 30, 2004, the entire disclosure of which is incorporated herein by reference. The inMotion™ was a groundbreaking product which, for the first time, provided powered speakers integrated with a docking station for a portable media player in a relatively lightweight and compact portable package that folded to protect the speaker drivers during transport. While the inMotion™ offered great advantages in terms of sound reproduction quality, robustness, weight, portability, size, and ease-of-use, room for improvement in each of these qualities remains.

### SUMMARY OF THE INVENTION

The present invention is directed to a portable media reproduction system that substantially obviates one or more of the limitations of the related art.

It is an object of the invention to provide a portable media reproduction system for use with a PMP wherein at least one speaker, subwoofer, or other audio reproduction device is incorporated within a housing, the housing also including a docking component operably connected thereto, the docking component being adjustable, such that the PMP can be securely seated therein, and to allow the portable media reproduction system to be operable with PMP's of differing dimensions, including differing depths.

Another object of the invention is to provide a portable media reproduction system which is comprised of at least one audio reproduction device incorporated within a housing, the housing also including a docking component operably connected thereto, and at least one video output connector.

Still another object of the invention is to provide a portable media reproduction system for use with a PMP, the portable media reproduction system including a docking component for the PMP, wherein a plurality of active speaker components are arranged substantially coplanar with a first side of a housing. In this embodiment, a subwoofer and at least one passive radiator are also incorporated in the housing, the subwoofer and the at least one passive radiator can be aligned such that they are substantially perpendicular to the first side.

It is to be understood that both the foregoing general description and the following detailed description are exemplary and explanatory and are intended to provide further explanation of the invention as claimed. Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1 is a front elevational view of a portable media reproduction system according to an embodiment of the present invention.

FIG. 2 is a front perspective view of the portable media reproduction system according to an embodiment of the present invention.

FIG. 3 is a rear view of a portable media reproduction system according to an embodiment of the present invention.

FIG. 4 is a side view of portable media reproduction system according to an embodiment of the present invention.

FIG. 5 is a cut-away rear perspective view of a portable media reproduction system according to an embodiment of the present invention.

FIG. 6 is a front perspective view of a docking component according to an embodiment of the present invention.

FIG. 7 is an exploded perspective view of a docking component according to an embodiment of the present invention.

FIG. 8a is a front plan view of portions of a docking component according to an embodiment of the present invention, the docking component being in a compressed state.

FIG. 8b is a cut-away left side view of the docking component portions illustrated in FIG. 8a.

FIG. 9a is a front plan view of portions of a docking component according to an embodiment of the present invention, the docking component being in a partially expanded state.

FIG. 9b is a cut-away left side view of the docking component portions illustrated in FIG. 9a.

### DETAILED DESCRIPTION OF THE PREFERRED EMBODIMENT

Reference will now be made in detail to the preferred embodiments of the present invention, examples of which are illustrated in the accompanying drawings. For clarity, corresponding features are consistently labeled across the various views of the invention provided in the figures.

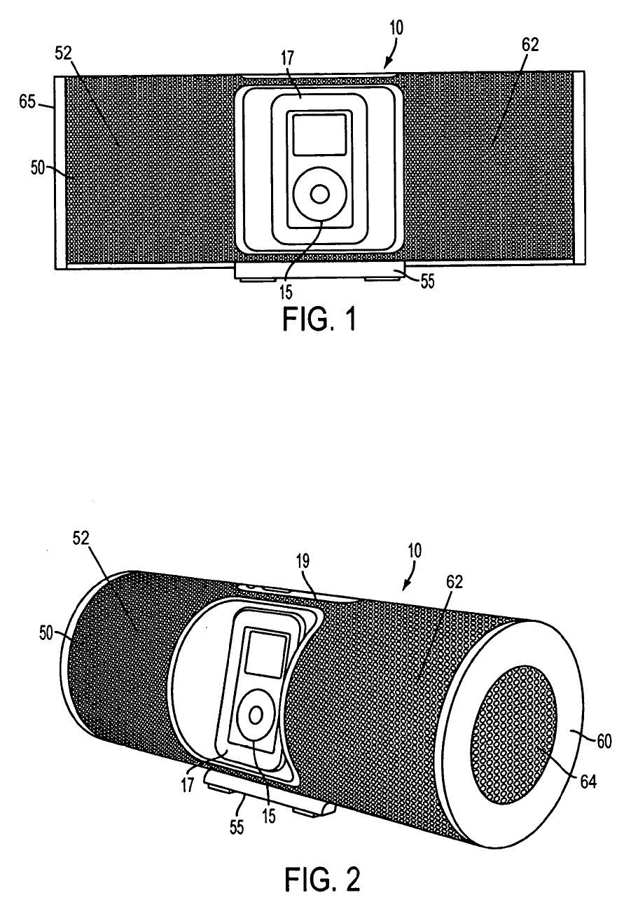

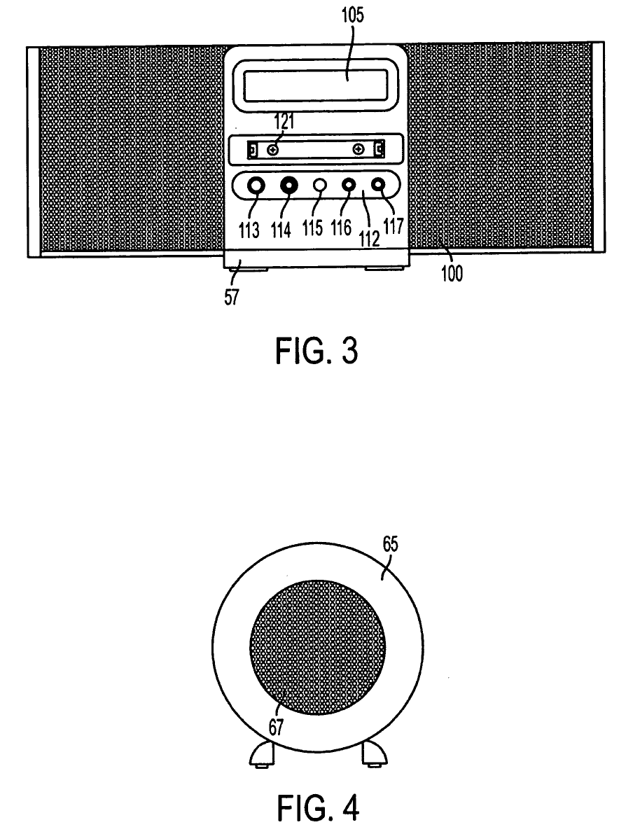

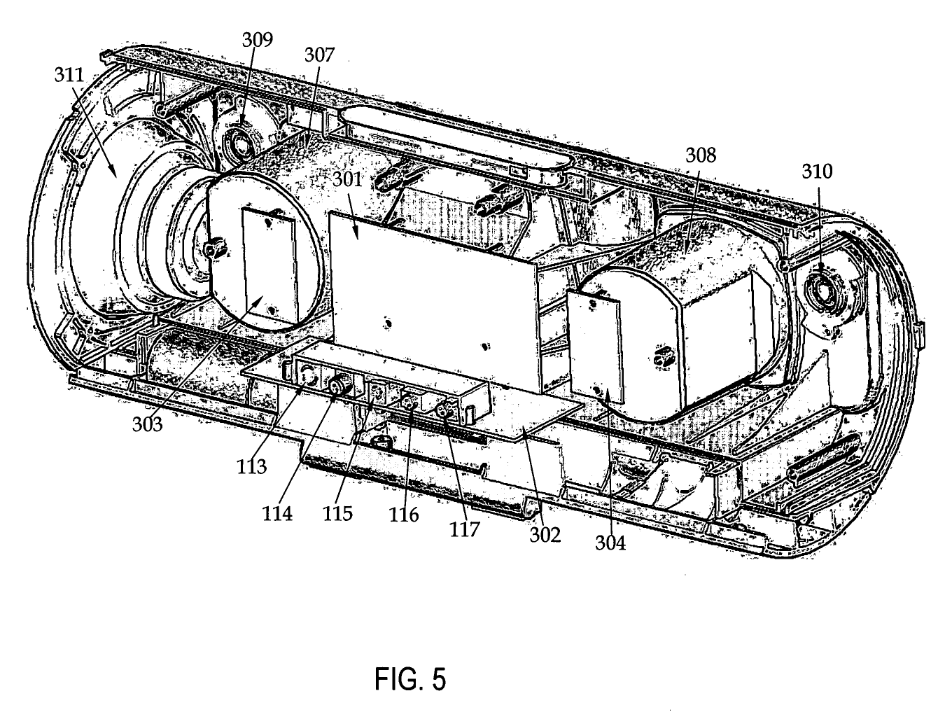

FIGS. 1 and 2 illustrate a portable media reproduction system housing 10 having a front surface 50, left side 60, right side 65, and back surface 100 (FIG. 3). In the illustrated embodiment, the front surface 50 has a left speaker array 62 and a right speaker array 52 arranged substantially coplanar with front surface 50. Although a substantially coplanar arrangement is disclosed herein, it should be apparent to one skilled in the art that left speaker array 62 and right speaker array 62 can be positioned in alternative arrangements, or made independently or jointly articulable, without departing from the spirit or the scope of the invention.

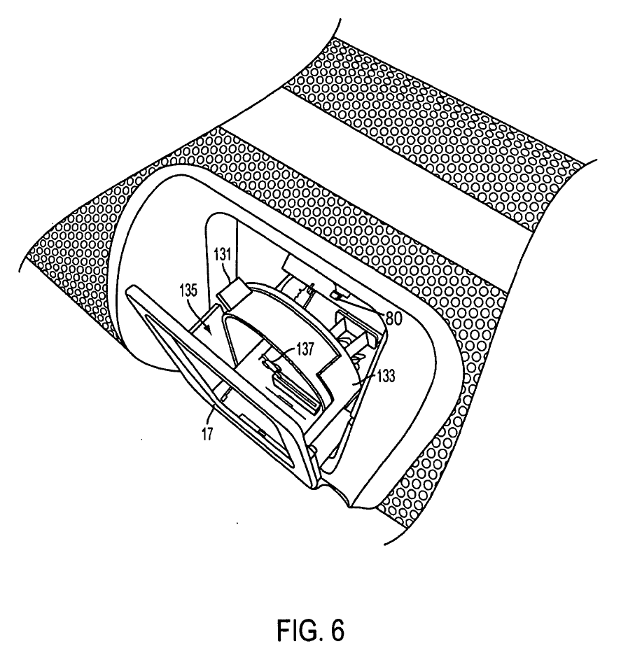

In the embodiment illustrated in FIGS. 1 and 2, front surface 50 also includes a door 17 through which a user can access PMP docking component 135, illustrated in FIG. 6. PMP docking component 135 can contain one or more interconnects through which PMP 15 can be connected to portable media reproduction system 10. In the illustrated embodiment, such an interconnect comprises a male docking port capable of mating with an equivalent female docking port in the bottom of PMP 15. However, it should be apparent to one skilled in the art that alternative interconnects can be substituted therefor without departing from the spirit or the scope of the invention. By way of example, without limitation, alternative interconnects may include BlueTooth™ or other wireless interconnection technologies, as well as wired interconnects such as those utilizing RCA, DIN, MINI-DIN, Stereo Mini Plug, or other connectors. This can allow portable media reproduction system 10 to be used with a variety of devices, including, without limitation, cellular phones, satellite radio receivers, digital radio receivers, standard radio receivers, CD players, portable digital assistants, digital cameras, or other portable audio and/or video devices.

In the embodiment illustrated in FIG. 4, left and right speaker arrays 62, 52 each have a 3″ full-range neodymium driver 307, 308 and a 1″ neodymium tweeter 309, 310. However, one of ordinary skill in the art would appreciate that alternative audio reproduction devices can be substituted therefor without departing from the spirit or the scope of the invention. In the illustrated embodiment, left and right speaker arrays 62, 52 are also covered with a perforated guard or screen to protect drivers 307, 308 and tweeters 309, 310.

In the illustrated embodiment, portable media reproduction system 10 also includes at least one four-inch side-firing subwoofer 311. Subwoofer 311 can be protected by perforated guard or screen 64. Because subwoofer 311 is a side-firing subwoofer, the face of subwoofer 311 need not be aimed directly at a user or other person experiencing the media reproduced by portable media reproduction system 10. Thus, in the illustrated embodiment, the face of subwoofer 311 is arranged substantially perpendicular to the plane of front surface 50. This allows portable media reproduction system 10 to be more compact without sacrificing sound quality.

Although not necessary to reproduce sound, the illustrated embodiment of portable media reproduction system 10 also includes a passive radiator 67. Passive radiator 67 allows sound waves generated behind subwoofer 311 to propagate out of portable media reproduction system 10, thus further improving the perceived bass response of the system. Using a passive radiator 67, as opposed to porting the speaker enclosure, permits an embodiment of the invention to be sealed. Because the portable media reproduction system 10 is portable, a sealed environment may help prevent moisture or foreign objects from entering enclosure. Such a preventative design protects the components, including the internal electronics, of system 10.

Portable media reproduction system 10 can also include control panel 19. In the illustrated embodiment, control panel 19 includes a plurality of membrane type buttons. Such buttons can allow a user to control various features of portable media reproduction system 10 including, but not limited to, power, master volume, bass amplification level, treble amplification level, and the like. Control panel 19 can also provide a convenient interface through which functions associated with PMP 15 can be controlled, including, without limitation, initiating playback, stopping and/or pausing playback, fast forwarding playback, and skipping to a new audio or video track.

As illustrated in FIGS. 1 and 2, an embodiment of the invention may be substantially cylindrical in shape. To help keep such an embodiment from rolling when placed on a given surface, portable media reproduction system may have one or more feet 55, 57.

FIG. 3 is a rear view of an embodiment of portable media reproduction system 10. In the illustrated embodiment, back surface 100 includes a recessed handle 105, to facilitate transporting portable media reproduction system 10. Back surface 100 can also include jack panel 112. Jack panel 112 allows portable media reproduction system 10 to be connected to additional, external devices through a variety of connectors, including powerjack 115, s-video jack 113, composite jack 1144, headphone jack 116, and auxiliary output jack 117. It should be apparent to one skilled in the art that alternative connectors can be substituted therefor without departing from the spirit or the scope of the invention.

Power jack 115 allows portable media reproduction device 10 to be connected to an AC to DC converter or other external power source. Power jack 115 preferably allows portable media reproduction system 10 to be powered from an external power source, such as, but not limited to, an AC to DC converter or external battery pack. In addition to receiving power from an external power source, portable media reproduction system 10 can also preferably be powered by one or more batteries, which are preferably stored within portable media reproduction system 10. Although rechargeable batteries, such as, but not limited to, lithium ion batteries, are presently preferred, it should be apparent to one skilled in the art that disposable batteries can be substituted therefor without departing from the spirit or the scope of the invention.

When PMP 15 is inserted in docking component 135, PMP 15 maybe powered by portable media reproduction system 10. In one embodiment, portable media reproduction system 10 may only supply power to PMP 15 when portable media reproduction system 10 is receiving power from an external power source, such as, but not limited to, an AC to DC converter, or to an external device capable of providing power to portable media reproduction system 10. In an alternative embodiment, portable media reproduction system 10 may supply power to PMP 15 regardless of whether the portable media reproduction system 10 is operating on power from an external power source or from internal batteries. In addition to allowing PMP 15 to function, power supplied by portable audio reproduction system 10 to PMP 15 may also allow PMP 15 to charge any rechargeable batteries stored therein.

Power from a power adapter, an externally connected device, and/or batteries may also be used to power at least one Class D or other audio amplifier 301-304 housed within portable media reproduction system 10, as well as other aspects of the system. A Class D amplifier is advantageous because of the relatively high efficiencies associated with such amplifiers. Such efficiencies provide reduced power consumption over conventional amplifiers, thereby improving the system's battery life. The amplifier is preferably used to convert the audio signals from media device into a signal capable of driving the speakers.

The illustrated embodiment of back surface 100 also includes a recess for storage of a remote control (not illustrated). In the illustrated embodiment, such a remote control allows a user to control the same features described above with respect to control panel 19. In an alternative embodiment, a user can control a subset of the features described above with respect to control panel 19. In still an alternative embodiment, a remote control may allow a user to control features not available through control panel 19.

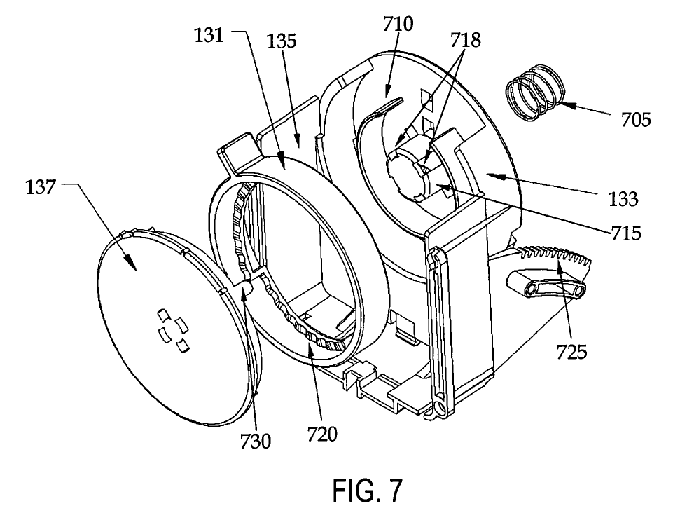

Referring to FIGS. 6 and 7, latch 80 holds docking component 135 in the closed position by friction. By pressing door 17 of docking component 135 toward latch 80, docking component 135 is released from latch 80. Docking component 135 can open using a soft open technique. In one embodiment of such a technique, a spring mechanism (not illustrated), in conjunction with damping mechanism 725, allows docking component 135 to gently articulate into an open position, thereby avoiding subjecting PMP 15 to the sudden shock that would otherwise occur when docking component 135 reached the end of its travel.

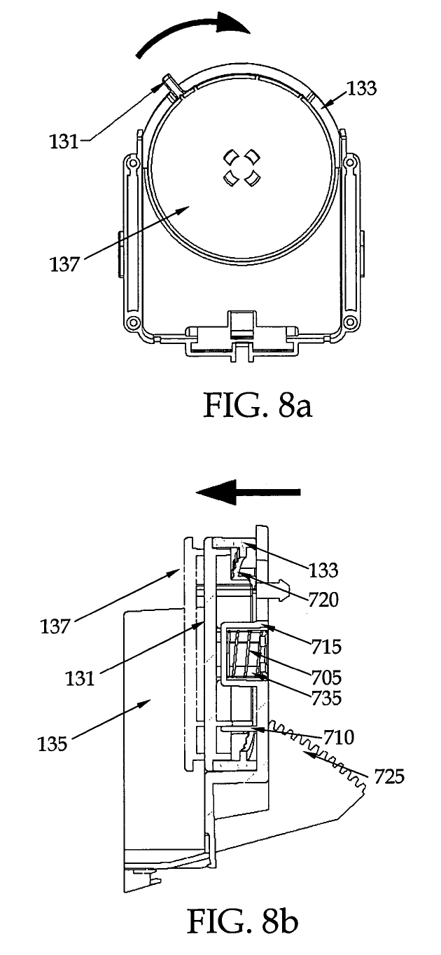

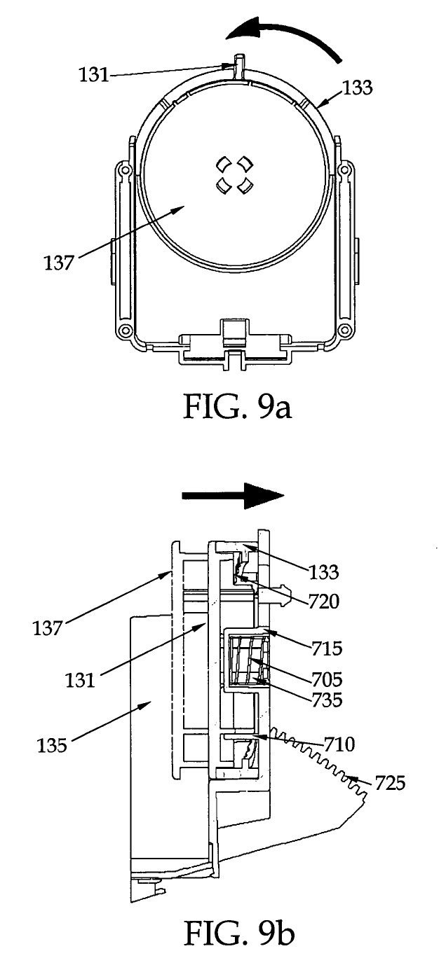

When a PMP is mounted in docking component 135, the back of the PMP can rest against shoe 137. In the embodiments illustrated in FIGS. 6-9b, the depth of docking component 135 can be adjusted by moving lever 131. In the illustrated embodiment, lever 131 is rotatable through approximately seventy-five (75) degrees within lever base 133. Moving lever 131 causes shoe 137 to move in or out. This functionality is achieved in the illustrated embodiment by proving shoe 137 with a plurality of stationary posts 725, each such stationary post being a different length such that the surface of shoe 137 remains substantially parallel to the back of the PMP. Stationary posts 725 are designed to fit inside scalloped edges cut in an inclined plane 720 on lever 131. As lever 131 is operated, the inclined plane rotates under stationary posts 725, causing shoe 137 to move in or out. By placing spring 705 between retainer clips 735 (see FIGS. 8b and 9b) and retainer 715, spring 705 can exert a force against retainer 715, thereby pulling shoe 137 into the scalloped edges of lever 131.

It should be apparent to one skilled in the art that although the above disclosure focuses on adjusting the depth of docking component 135, similar techniques can also be used to adjust the width and height of docking component 135. It should also be apparent to one skilled in the art that alternative techniques for adjusting the size of docking component 135, such as by way of an inflatable tube in lieu of lever 131 and stationary posts 725, can be substituted therefor, without departing from the spirit or the scope of the invention.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

1. A portable media reproduction system comprising:
a housing having a first surface and a second surface;
at least one speaker for audio reproduction; and
an adjustable docking component operably connected to the first surface of the housing for receiving a portable media player, wherein at least the depth of the docking component is adjustable to accommodate the portable media player.

2. The portable media reproduction system of claim 1, wherein the adjustable docking component width is also adjustable.

3. The portable media reproduction system of claim 1, wherein the adjustable docking component height is also adjustable.

4. The portable media reproduction system of claim 2, wherein the adjustable docking component height is also adjustable.

5. The portable media reproduction system of claim 1, wherein the adjustable docking component is operably connected to the housing using a soft open technique.

6. The portable media reproduction system of claim 1, wherein the adjustable docking component comprises a shoe, operably connected to a base by a lever, wherein the lever adjusts the depth of the shoe.

7. The portable media reproduction system of claim 6, wherein sliding of the lever causes the shoe depth to adjust.

8. The portable media reproduction system of claim 6, wherein rotation of the lever causes the shoe depth to adjust.

9. The portable media reproduction system of claim 6, wherein the lever comprises an inner surface and an outer surface, the inner surface having a plurality of raised notches extending therefrom, further comprising at least one stationary post connected to the shoe, wherein the at least one stationary post is positioned to contact at least one of the raised notches.

10. The portable media reproduction system of claim 9, further comprising a retainer, wherein the retainer has a plurality of notches, wherein the shoe further comprises a plurality of retainer clips, the retainer clips mating with the plurality of notches in the retainer.

11. The portable media reproduction system of claim 10, further comprising a spring, operably inserted between the plurality of retainer clips and the retainer.

12. The portable media reproduction system of claim 9, wherein the raised notches are each at a different height.

13. The portable media reproduction system of claim 12, further comprising a plurality of stationary posts, wherein each of the stationary posts is of a length chosen such that a surface of the shoe will remain substantially coplanar with a portable media device when the portable media device is inserted into the adjustable docking component.

14. The portable media reproduction system of claim 1, wherein the adjustable docking component comprises a shoe movably connected to a base, and wherein a lever adjusts the depth of the shoe.

15. The portable media reproduction system of claim 14, wherein the shoe is movably connected to the base by an apparatus comprising a substantially inclined ramp disposed circularly within the adjustable docking component and a matching component contacting the ramp, and wherein the lever adjusts the depth of the shoe by changing the orientation of the ramp and the matching component.

16. The portable media reproduction system of claim 15, further comprising a securing structure for holding the lever in a plurality of positions.

17. The portable media reproduction system of claim 16, wherein the securing structure comprises scalloping on a surface of the inclined ramp.

18. The portable media reproduction system of claim 17, further comprising a spring means for urging engagement of the ramp and matching component.

19. The portable media reproduction system of claim 1, further comprising:
a connector within the adjustable docking component, the connector being adapted to electronically engage a portable media player when the portable media player is received in the docking component;
an amplifier adapted to provide amplification for an audio signal produced by a portable media player when such portable media player is electronically engaged with the connector; and
a power source for powering the amplifier.

20. The portable media reproduction system of claim 19, wherein the power source comprises at least one battery.

21. The portable media reproduction system of claim 20, wherein the at least one batter is rechargeable.

22. The portable audio reproduction system of claim 19, wherein the at least one power source is a DC power source.

23. The portable audio reproduction system of claim 19, wherein the at least one power source is an AC power source.

24. The portable audio reproduction system of claim 19, further comprising a remote, the remote adapted to control at least one function of a portable media player when such portable media player is electronically engaged with the connector.

25. A portable media reproduction system comprising:
a housing having a first side and a second side;
a docking component on the first side for receiving a portable media player, the docking component having an open position for receiving a portable media player, and a closed position for retaining the portable media player;
at least one speaker for audio reproduction; and,
at least one video output connector.

26. The portable media reproduction system of claim 25, wherein the at least one video output connector is an S-Video connector.

27. The portable media reproduction system of claim 25, wherein the at least one video output connector is a composite video connector.

28. A portable media reproduction system comprising:
an enclosure having a cavity;
a docking component for receiving a portable media player, the docking component operatively engaged with the enclosure;
a plurality of active speaker components mounted on the enclosure, wherein at least two of the plurality of active speaker components are arranged substantially coplanar with each other;
at least one of the plurality of active speaker components mounted to the enclosure, the at least one of the plurality of active speaker components being arranged such that, in use, it compresses and decompresses air within the enclosure cavity;
at least one passive speaker component mounted to the enclosure, the at least one passive speaker component being adapted to move in response to air pressure; and
wherein, the enclosure cavity is protected by at least the subwoofer and passive radiator, and comprises a substantially sealed environment that resists moisture and foreign objects from entering into the cavity.

29. A portable media reproduction system comprising:
a generally cylindrical housing having a first end and a second end, the generally cylindrical housing also having with a compartment therein defined by a movable support structure;
the movable support structure having an open and a closed position, and being adapted to house and electronically engage a portable media player in the closed position;
at least one active speaker component mounted to the first end;
at least one active speaker component oriented at an angle of between 70 and 110 degrees with respect to the first end;
an amplifier enclosed within the generally cylindrical housing, the amplifier providing amplification for an audio signal produced by a portable media player electronically engaged with the movable support structure, and sending an amplified audio signal to the at least one active speaker component mounted to the first end and the at least one active speaker component oriented at an angle of between 70 and 110 degrees with respect to the first end;

30. A portable media reproduction system according to claim 29, further comprising a second active speaker component oriented at an angle of between 70 and 110 degrees with respect to the first end.

31. A portable media reproduction system according to claim 29, further comprising at least one passive speaker component mounted to the second end.
